(19) United States
(12) Patent Application Publication
(10) Pub. No.: US 2018/0242783 A1
(43) Pub. Date: Aug. 30, 2018

(54) Systems and Methods For Making a Hybrid Waffle-Pancake

(71) Applicant: Panwaffle, LLC, Horseshoe Bay, TX (US)

(72) Inventors: Turner Lucas Zeutzius, Horseshoe Bay, TX (US); Adrian Slattery, Rocky River, OH (US); Bruce Coderre, Arlington, VA (US); Douglas Halley, Westlake, OH (US)

(73) Assignee: Panwaffle, LLC

(21) Appl. No.: 15/443,631

(22) Filed: Feb. 27, 2017

(51) Int. Cl. A47J 37/06; A47J 36/00

(52) U.S. Cl. CPC A47J 37/0611; A47J 36/00

(57) ABSTRACT

The present invention discloses a waffle iron or cooking press that enables a user to cook a waffle and pancake simultaneously. This waffle iron or cooking press may include a lid and a base, where the base has a thicker profile that offers a reservoir to hold and cook the hybrid waffle-pancake. An insulated lid handle and insulated base handle are designed to enable a user to open, close, and flip the waffle iron during the cooking process. A hinge mechanism may connect the lid to the base. This mechanism keeps the lid and base attached in the closed position and when the user opens the waffle iron, but also enables the user to detach the lid from the base. The lid and base each include complementary textured cooking surfaces and flat cooking surfaces.

### TECHNICAL FIELD

The present invention relates generally to a waffle iron or cooking press and, more specifically, to a waffle iron or cooking press that makes a hybrid waffle-pancake.

### BACKGROUND OF THE INVENTION

The debate has raged on for years—waffles or pancakes? Some people like waffles better and some like pancakes, but before this invention, no one has been able to enjoy a waffle/pancake, hybrid waffle-pancake, or a “panwaffle.” This breakfast treat caters to those that enjoy both waffles and pancakes. The differences between waffles and pancakes made it difficult to cook or create a hybrid waffle-pancake, but the invention described herein resolves these problems in order to create this breakfast item.

A traditional waffle is firm, crispy, and textured, while a pancake is fluffy and flat. A waffle is cooked in a waffle iron or a waffle press, while a pancake is cooked on a flattop grill, in a pan, or with a pancake press. During cooking, a waffle is enclosed in a waffle iron or press, while a pancake is traditionally cooked on an open flattop grill. Further, waffle batter has been different than pancake batter and cook times have been different. This creates problems with cooking a hybrid waffle-pancake. In prior embodiments, a waffle iron or waffle press has been able to cook a waffle, but not an additional pancake. Similarly, a pancake press has been able to cook a flat pancake, but not a textured waffle.

The invention disclosed herein solves additional problems with traditional waffle irons. Prior waffle irons have proven difficult to keep the lid and base together during cooking or separate them for cleaning. Either the lid is separate from the base, which creates problems during the cooking of the waffle, or the lid is firmly connected to the base which creates problems during cleaning.

### BRIEF SUMMARY OF THE INVENTION

This invention solves these problems by enabling a user to create a hybrid waffle-pancake in the same waffle iron or cooking press. The same batter and cook time may be used to create the waffle/pancake or “panwaffle.” What previously required separate batters, cooking surfaces, cooking times, and utensils can now be prepared with a single waffle iron or cooking press. In some embodiments, the finished waffle is created in the center of and is connected to the pancake, which surrounds the waffle. This enables a user to enjoy a waffle and a pancake in the same breakfast item.

Non-electric and electric waffle irons or cooking presses are disclosed in this application. In some embodiments, non-electric waffle irons or cooking presses may include a lid and a base, where the base has a thicker profile that provides a reservoir to cook the hybrid waffle-pancake. An insulated lid handle and insulated base handle are correspondingly connected to a first end of the lid and a first end of the base and are designed to enable a user to open, close, and flip the waffle iron during the cooking process. A hinge mechanism may connect the lid to the base at second ends of the lid and base. This mechanism keeps the lid and base attached while the user opens the waffle iron. The hinge mechanism may also enable the user to detach the lid from the base. The lid includes a waffle cooking surface and a pancake cooking surface, while the base includes a complementary waffle cooking surface and a complementary pancake cooking surface. The waffle cooking surfaces are textured, while the pancake cooking surfaces are flat.

The electric waffle irons or cooking presses may have a lid and a base also, with a hinge mechanism that connects the lid to the base at second ends of the lid and the base. The first end of the lid may have an insulated lid handle and the first end of the base may have an insulated base handle. These handles enable the user to open and close the waffle iron during the cooking process. While the non-electric waffle irons or cooking presses may be used with a flattop, stove, or hot plate, the electric waffle irons or cooking presses may contain at least one heating element to warm the cooking surfaces of the lid and base. As with the non-electric waffle iron, the lid and base include complementary waffle and pancake cooking surfaces.

In some embodiments, the hinge mechanism may include first and second lid knuckles and first and second base knuckles that are attached to the corresponding lid and base. Through the use of protrusions and complementary apertures, the first lid knuckle is removably attached to the first base knuckle and the second lid knuckle is removably attached to the second base knuckle. While this ensures that the lid remains attached to the base during operation, the lid may be detached from the base by separating the first lid knuckle from the first base knuckle and the second lid knuckle from the second base knuckle. One or more additional bosses on the lid or base may prevent the lid from separating from the base throughout most of the range of motion. A user may only be able to separate the lid from the base when this boss lines up with an aperture on an adjacent knuckle of the base or lid.

This application also discloses an electric heating apparatus that may be used in conjunction with the non-electric waffle iron or cooking press. This heating apparatus includes a first and second heating plate that are designed to (1) share the same rotational axis as the lid and base and (2) contact the lid and base during operation. Thus, the first and second heating plates simultaneously cook the hybrid waffle-pancake. A lid handle on the heating apparatus enables a user to open and close the heating apparatus. With this heating apparatus, a flattop grill, stove, or hot plate is not required to cook the hybrid waffle-pancake.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIGS. 1A and 1B show a cooking press according to embodiments of the invention;

FIGS. 2A and 2B show the cooking press according to embodiments of the invention;

FIGS. 3A-3C show the cooking press n according to embodiments of the invention;

FIGS. 4A-4C show a base of the cooking press according to embodiments of the invention;

FIGS. 5A-5C show a lid of the cooking press according to embodiments of the invention;

FIGS. 6A and 6B show a hinge of the cooking press according to embodiments of the invention;

FIGS. 7A and 7B show the hinge of the cooking press according to embodiments of the invention;

FIGS. 8A-8C show a handle of the cooking press according to embodiments of the invention;

FIGS. 9A-9B show a cooking press according to embodiments of the invention;

FIGS. 10A and 10B show the cooking press according to embodiments of the invention;

FIGS. 11A-11C show the cooking press according to embodiments of the invention;

FIGS. 12A and 12B show a hinge of a cooking press according to embodiments of the invention;

FIGS. 13A and 13B show the hinge of a cooking press according to embodiments of the invention;

FIGS. 14A-14D show an electric heating apparatus for the cooking press according to embodiments of the invention;

FIGS. 15A and 15B show the electric heating apparatus for the cooking press according to embodiments of the invention;

FIG. 16 shows an exploded view of the electric heating apparatus for the cooking press according to embodiments of the invention;

FIGS. 17A and 17B show an electric cooking press according to embodiments of the invention;

FIG. 18 shows an exploded view of the electric cooking press according to embodiments of the invention;

FIGS. 19A and 19B show an electric cooking press according to embodiments of the invention;

FIG. 20 shows an exploded view of the electric cooking press according to embodiments of the invention;

FIGS. 21A and 21B show a cooking press according to embodiments of the invention; and

FIGS. 22A and 22B show a handle of the cooking press according to embodiments of the invention.

### DETAILED DESCRIPTION OF THE INVENTION

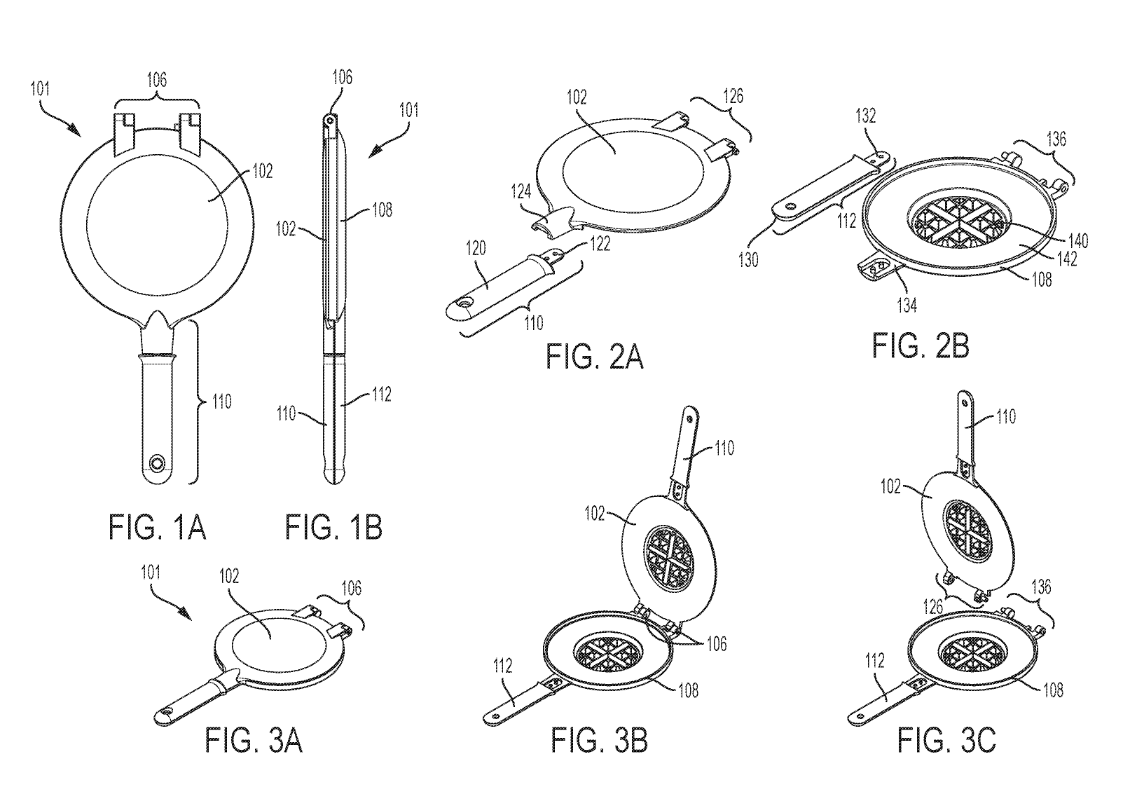

FIG. 1A illustrates a top view of a waffle iron or cooking press 101 according to embodiments of the invention. This waffle iron or cooking press 101 is designed to cook a waffle and a pancake at the same time. In some embodiments, the waffle is connected to the pancake, such that the finished product is a hybrid waffle-pancake or a “panwaffle.” A lid 102 is connected to a lid handle 110 and a hinge 106, which connects the lid to a base 108 of the waffle iron 101. The lid 102 is designed to enclose and cook the hybrid waffle-pancake. The lid handle 110 is adapted to allow a user to touch the handle 110 and adjust the lid 102 as desired. The hinge 106 comprises two portions that provide a removable connection between the lid 102 and the base 108.

FIG. 1B illustrates a side view of the waffle iron or cooking press 101. The hinge 106 connects the lid 102 to the base 108 of the waffle iron or cooking press 101. Similar to the lid handle 110, the base handle 112 is connected to the base 108 and is adapted to allow a user to touch the handle 112 and adjust the base 108 as desired. Through the lid handle 110 and/or the base handle 112, the user may open and close the waffle iron 101. The hinge 106 is designed to allow this range of motion. The base 108 is thicker or deeper than the lid 102. Thus, the lid 102 and base 108 are not symmetrical about a horizontal plane. These features of the waffle iron or cooking press 101 are further described herein.

The lid handle 110 must at least be flush with the top side of the lid 102 and the base handle 112 must at least be flush with the bottom side of the base 108. This allows the user to lay the lid 102 or the base 108 flat on a stovetop, flattop grill, hot plate, etc. Further, the handles 110, 112 may be thin enough to enable the lid 102 and base 108 to completely close for cooking.

FIG. 2A illustrates a perspective view of the lid 102. The lid handle 110 includes a lid handle grip 120 and a lid handle tang 122. The tang 122 fits into the grip 120 to provide strength and rigidity to the lid handle 110. The lid handle 110 is connected to the lid 102 through a lid connector 124. There are two protrusions on the lid connector 124 that fit into two holes in the tang 122 for this connection. FIG. 2B illustrates a perspective view of the base 108. The base handle 112 includes a base handle grip 130 and a base handle tang 132. The tang 132 fits into the grip 130 to provide strength and rigidity to the base handle 112. The base handle 112 is connected to the base 108 through a base connector 134. As with the lid 102, there are two protrusions on the base connector 134 that fit into two holes in the tang 132 for this connection. FIGS. 2A and 2B illustrate a type of form fitting for the handles 110, 112 and the connectors 124, 134, however, the handles 110, 112 may connect to the connectors 124, 134 through various methods, including welding, form fitting, fasteners, bolts, etc. In some embodiments, the user may connect the handles 110, 112 to the connectors 124, 134 with a fastener or bolt. The handles 110, 112 may be detachable, such that a user will only attach the handles 110, 112 when adjusting the waffle iron 101. In another embodiment, the handles 110, 112 are an extension of the corresponding lid 102 and base 108, such that connectors 124, 134 are not required. However, by using two different materials or sections for the lid 102 and the lid handle 110, this design slows the transfer of heat from the lid 102 to the lid handle 110 in order to control the temperature of the handle. The handle grips 120, 130 should also be designed to limit the heat transfer from the lid 102 and base 108 to the handles 110, 112.

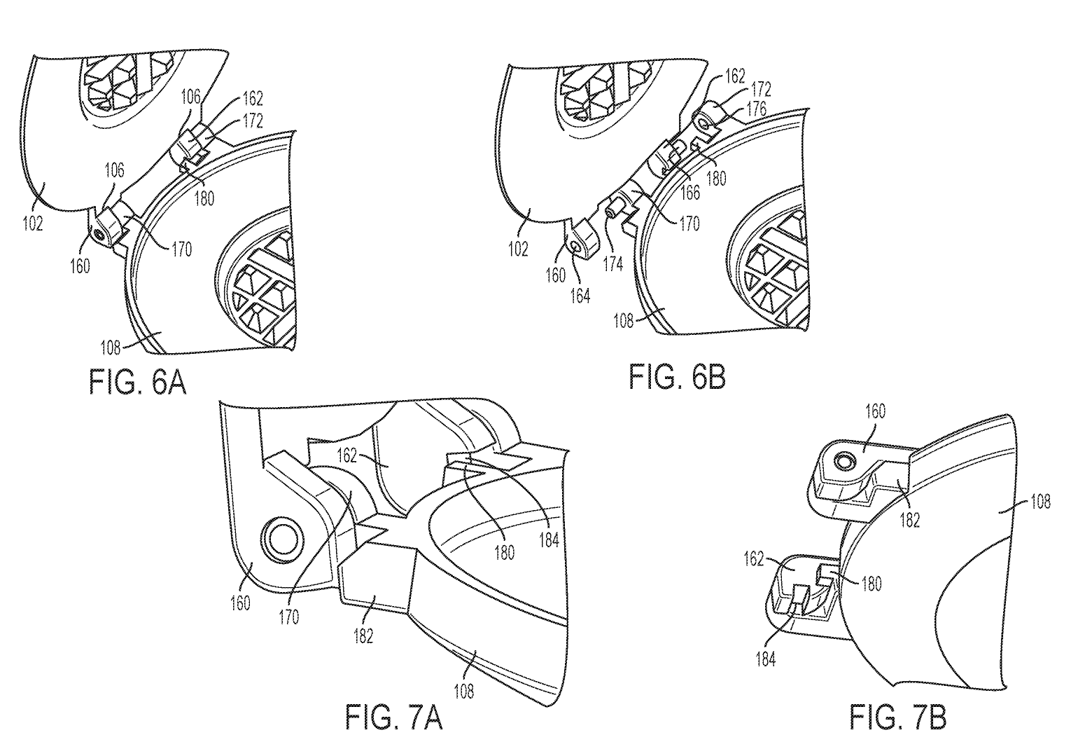

FIGS. 2A and 2B also illustrate a top portion of the hinge 126 connected to the lid 102 and a bottom portion of the hinge 136 connected to the base 108. These portions of the hinge 126, 136 are further described with reference to FIGS. 6 and 7. As shown in FIGS. 3A-3C, the top 126 and bottom 136 portions of the hinge provide a removable connection between the lid 102 and the base 108. FIG. 2B further shows a base waffle surface 140 for cooking a waffle and a base pancake surface 142 for cooking a pancake. The base waffle surface 140 includes numerous protrusions, ridges, apertures, and gaps for creating a textured waffle. In some embodiments, the waffle surface 140 is a grid design. Various designs for this waffle surface 140 can be used to create the desired waffle. For example, the waffle surface 140 may be deeper to create a thicker waffle, which would make the protrusions taller as well. There may be more protrusions to create more apertures or gaps within the waffle. Further, the shape of the protrusions and gaps (i.e., circles, triangles, etc.) may be different to create a different textured waffle. The base pancake surface 142 is a flatter surface for creating pancakes. The lid 102 contains complementary surfaces for cooking the waffle and pancake. When applied to heat, lid 102 and base 108 cook the waffle and pancake to the desired temperature and texture. The waffle surface 140 may be deeper than the pancake surface 140 so that the waffle portion of the end-product is thicker than the pancake portion.

FIGS. 3A-3C are perspective views of the waffle iron or cooking press 101 in closed, open, and detached configurations. As shown in FIG. 3A, the lid 102 and base 108 fit together when the waffle iron 101 is closed. The waffle iron 101 should remain closed when it is applied to heat and the waffle and pancake are cooking. The lid 102 and the base 108 provide a sealed fit to prevent waffle and/or pancake batter from escaping the waffle iron 101. In some embodiments, a latch may be used to keep the waffle iron 101 closed. FIG. 3B shows the waffle iron 101 open with close to a 90° angle between the lid 102 and the base 108. The open position enables the user to (1) check on the waffle and pancake during cooking and (2) remove the hybrid waffle-pancake when it has reached the desired temperature and texture. When finished cooking, the lid 102 is adjusted and due to its reduced surface area compared with the base 108, the hybrid waffle-pancake does not stick to its surface. FIG. 3C illustrates the detachment of the lid 102 from the base 108, which allows the user to easily clean the waffle iron 101 after use. The design of the hinge 106 enables the top portion of the hinge 126 to separate from the bottom portion of the hinge 136.

While FIGS. 1A-3C illustrate a waffle iron or cooking press for creating a hybrid waffle-pancake, wherein the interior waffle is circular and the circular pancake connects to and surrounds the waffle, this disclosure includes alternative embodiments. For example, the waffle iron or cooking press 101 may produce a waffle that is adjacent to a pancake and not surrounded by one. The waffle iron may produce an interior pancake that is circular and is surrounded by a waffle. The hybrid waffle-pancake may take other shapes, such as squares, rectangles, decorative shapes, or cartoon characters. For example, the interior waffle may resemble a heart that is surrounded by a heart-shaped pancake, or the waffle may be a cartoon character surrounded by a pancake. An advantage of the waffle portion is to hold butter and syrup in the waffle's crevices for the user to enjoy on the waffle portion and pancake portion. This may lead to strategic location of the waffle portion of the waffle iron 101. For example, there may be numerous waffle portions provided throughout the pancake to capture butter and syrup for the hybrid waffle-pancake. This disclosure is not limited to waffles and pancakes though, as other foodstuffs could be heated and cooking in the disclosed cooking press 101. For example, an egg may be deposited in the waffle cooking surface to create an egg surrounded by a pancake. Similarly, cornbread batter may be deposited in the waffle cooking surface, while biscuits are cooked in the pancake surface to create cornbread and biscuits.

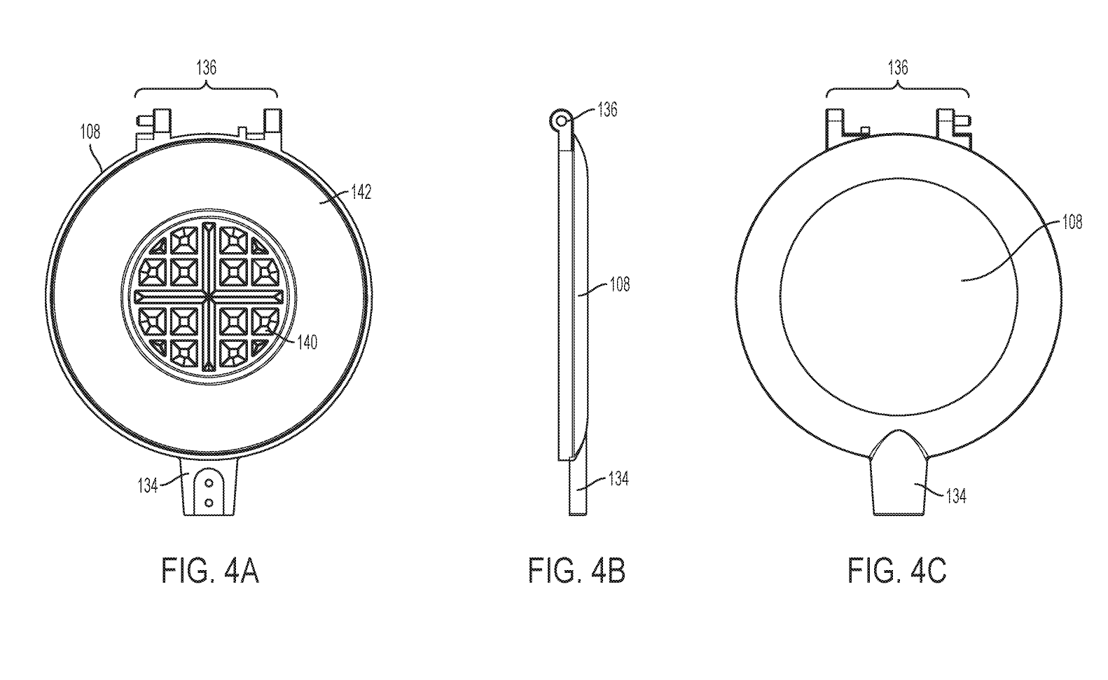

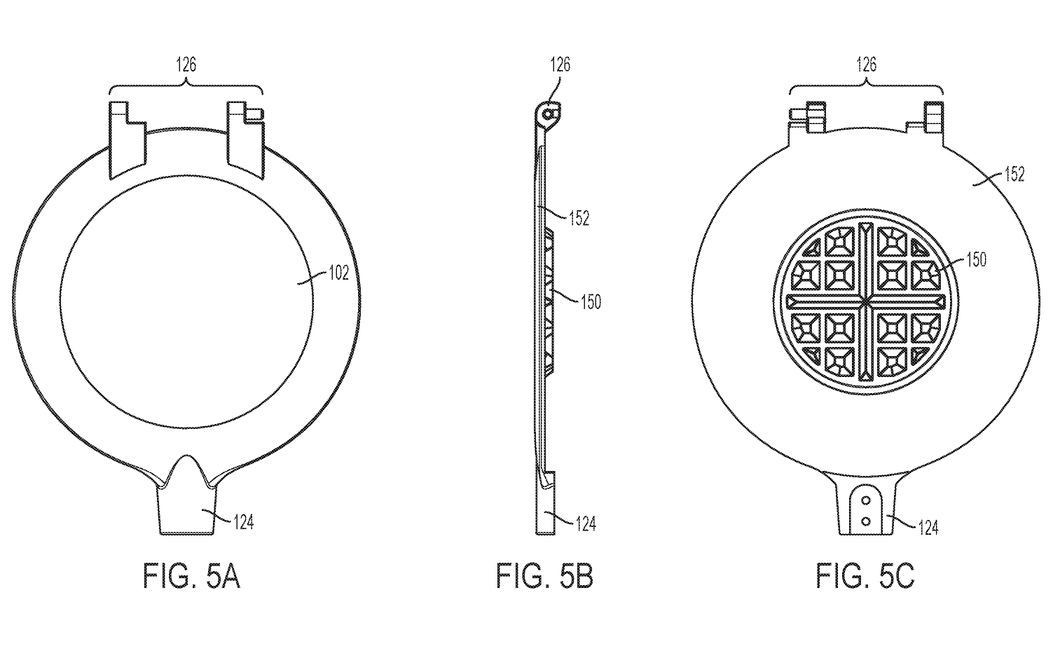

FIGS. 4A-4C illustrate top, side, and bottom views of the base 108. Specifically, FIG. 4A shows a top view of the base 101, with the pancake surface 142 and the waffle surface 140. Waffle or pancake batter is distributed in this reservoir portion of the base 108 before cooking. In this embodiment, the end-product will resemble a hybrid waffle-pancake, where the circular, thick waffle is surrounded by a pancake. The waffle surface 140 resides within a reservoir of the base 108. FIG. 4B shows a side view of the base 108, which is thicker than the lid 102 shown in FIG. 5B. FIG. 4C shows a bottom view of the base 108. This portion of the base is applied to heat for cooking the waffle and pancake. The base connector 134 and base portion of the hinge 136 are also shown. In some embodiments, the height of the base 108 is 0.96 inches or 24.3 mm from the bottom side of the base 108 to the top side of the bottom portion of the hinge 136. As the side walls of the base 108 do not extend this entire length, the distance from the bottom side of the base 108 to the top of the side walls of the base may be 0.6-0.8 inches or 15-20 mm. The side walls of the base 108 extend beyond the waffle surface 140.

FIGS. 5A-5C illustrate top, side, and bottom views of the lid 102. Specifically, FIG. 5A shows a top view of the lid 102, which is applied to heat for cooking the hybrid waffle-pancake. FIG. 5B shows a side view of the lid 102, which is thinner than the base 102 shown in FIG. 4B. There is a rib on the edge of the lid 102 to ensure that the waffle and pancake batter remain in the waffle iron or cooking press 101 during cooking. Further, the lid pancake surface 150 extends further than the rib of the lid 102 and into the base 108 during cooking. FIG. 5C shows a bottom view of the lid 102, which is designed to fit together with the complementary portion of the base 108. FIGS. 5B and 5C show the lid waffle surface 150 for cooking the waffle and the lid pancake surface 152 for cooking the pancake. The lid waffle surface 150 includes numerous protrusions, ridges, and gaps for creating a textured waffle. In some embodiments, the waffle surface 150 is a grid design. Various complementary designs for this waffle surface 150 can be used to create the desired waffle. The thinner profile of the lid 102 fits into the thicker base 105 to enclose the hybrid waffle-pancake during cooking. The lid pancake surface 152 is a flat surface for creating flat pancakes. As with the base 108, the lid waffle surface 150 is deeper than the lid pancake surface 152, so that the waffle portion of the end-product is thicker than the pancake portion. The lid connector 124 and the lid portion of the hinge 126 are also shown. In some embodiments, the height of the lid 102 is 0.46 inches or 11.7 mm from the bottom of the waffle surface 150 to the top side of the lid 102. For the lid 102, the waffle surface 150 extends beyond the side walls or rib of the lid 102. During cooking, the waffle surface 150 extends into the base 108. Thus, in some embodiments a cross section of the base 108 is over twice as thick as a cross section of the lid 102.

In some embodiments, the lid 102 and base 108 are primarily made of aluminum, cast iron, stainless steel, or ceramic materials, which are able to be used with high heat. If aluminum is used, then the outer surface of the lid 102 and base 108 should be hard black anozided, glass coated, ceramic coated, or silicone polyester coated. The visible surfaces of the interiors of the lid 102 and base 108, including the waffle surfaces 140, 150 and pancake surfaces 142, 152, may be coated with Teflon™. This creates a scratch-resistant cooking surface for the hybrid waffle-pancake. The materials may be chosen to ensure that the waffle iron 101 is dishwasher safe. In some embodiments, the connectors 124, 134 and the hinges 126, 136 are made of the same material as the lid 102 and the base 108.

FIGS. 6A and 6B illustrate the hinge 106 of the waffle iron or cooking press 101. The lid 102 includes a first lid knuckle 160 and a second lid knuckle 162. The base 108 includes a first base knuckle 170 and a second base knuckle 172 that slidably connect with the first lid knuckle 160 and the second lid knuckle 162. In this embodiment, the first lid knuckle 160 contains a hole or aperture 164 that houses a protrusion 174 of the first base knuckle 170. The second lid knuckle 162 contains a protrusion 166 that slides into a hole or aperture 176 of the second base knuckle 172. When in use, the protrusions 174, 166 fit in the holes or apertures 164, 176. When the user separates the lid 102 from the base 108, the protrusions 174, 166 slide out of the holes or apertures 164, 176. As shown in FIGS. 6A and 6B, the user may separate the lid 102 from the base 108 in the open position. As shown in FIGS. 7A and 7B, a base protrusion or boss 180 prevents the separation of the lid 102 from the 108 during operation in the closed position. Thus, the lid 102 will not separate from the base 108 during the cooking of the hybrid waffle-pancake.

FIGS. 7A and 7B illustrate the hinge 106 of the waffle iron or cooking press 101 in an open position (FIG. 7A) and a closed position (FIG. 7B). In the open position, an edge 182 in the base 108 prevents the lid 102 from opening past a specific angle—in this case 90°. While opening the waffle iron 101, the first lid knuckle 160 begins to rotate with respect to the first base knuckle 170, and the edge 182 blocks the corner of the first lid knuckle 160 when it reaches the desired angle. This keeps the waffle iron 101 from opening past the desired angle. Further, the second lid knuckle 162 includes a gap 184, to accommodate the base protrusion or boss 180 in this open position, which allows the user to slide the lid knuckles 160, 162 from the base knuckles 170, 172 to separate the lid 102 from the base 108. This gap 184 only allows the lid 102 to be separated from the base 108 in the open position. As shown in FIG. 7B, the base protrusion or boss 180 prevents the lid 102 from separating from the base 108 in the closed position.

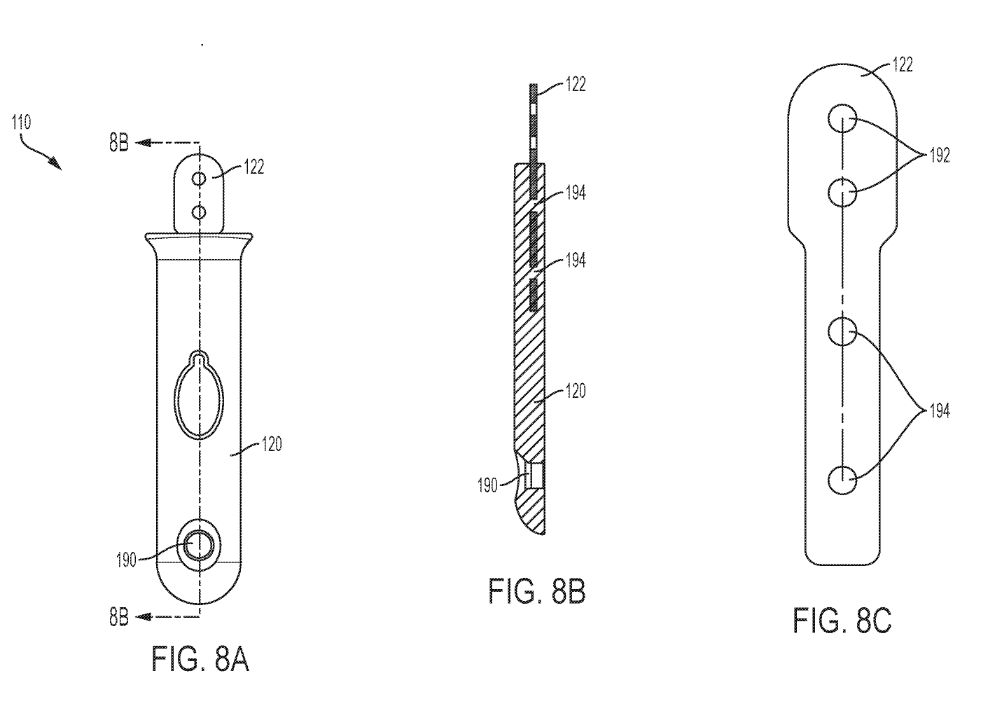

FIGS. 8A and 8B illustrate a top view and a cross section view of the lid handle 110, which connects to the lid 102. The base handle 112 is substantially similar, but may need to be thicker due to the thicker reservoir. FIG. 8C illustrates the lid tang 122 that fits in the lid handle 110. The lid tang 122 may be made of stainless steel or aluminum to provide strength and rigidity to the handle. The lid tang 122 has numerous holes or apertures 192, 194 throughout its length. The two holes 192 in the exposed section of the lid tang 122 are designed to connect to the lid connector 124. The remaining holes or apertures 194 are located inside the lid handle grip 120. The lid handle grip 120 surrounds the lid tang 122 with a cushioned surface that a user can grab and hold. In some embodiments, the lid handle grip 120 is a thermoset plastic material (i.e., Bakelite, Phenolic resins, etc.) that does not conduct heat well. Thus, the user can grab the lid handle grip 120 even when the lid is hot. During manufacturing, the holes 194 in the lid tang 122 fill with the thermoset plastic material to improve strength and durability of the lid handle 110. In some embodiments, the handles 110, 112 are detachable. The lid handle 110 also comprises an accessory hole 190 for a string or adjustable band to be inserted, which allows the user to hang the waffle iron 101 for storage. Even without the string or adjustable band, the user may hang the waffle iron 101 on a hook due to the accessory hole 190.

To create the hybrid waffle-pancake, the user selects a batter that will cook well in the waffle iron or cooking press 101. This may be a hybrid batter or batter formula consisting of a portion of a traditional waffle batter and a portion of a traditional pancake batter. In one embodiment, the user may mix 1.75 cups of flour, 0.5 cups of sugar, 3.5 teaspoons of baking powder, 2 large eggs, 1.5 cups of milk, 1 cup of melted butter, and 1 teaspoon of vanilla extract to create a batter that yields five hybrid waffle-pancakes. For a gluten-free option, the user may mix 1 cup of brown rice (or 1 cup of rice flour), 0.5 cups of potato starch, 0.25 cups of tapioca flour, 3.5 teaspoons of baking powder, 1 teaspoon of salt, 0.25 cups of oil, 2 large eggs, 1.5 cups of buttermilk, 0.25 cups of sugar, and 1 teaspoon of vanilla extract to create a batter that yields five hybrid waffle-pancakes. With both formulas, the user should mix the ingredients with a whisk and let the batter stand for five minutes.

Once the batter is finished, the user begins by heating the heating element, which could be a flattop grill, an oven, a stovetop grill, or a hot plate. The user should apply a cooking spray, olive oil, or butter to the cooking surfaces of the waffle iron or cooking press 101 to prevent the batter from sticking. Then, the base 108 of a closed waffle iron 101 is applied to the cooking surface at medium heat for two minutes to warm the waffle iron 101. The user uses the lid handle 110 to open the waffle iron 101, as shown in FIG. 3B, and the batter is applied within the reservoir of the base 108 to cover the waffle surface 140 and the pancake surface 142. The batter may be applied to fill the base reservoir about ⅔ of the way to the top to allow the hybrid waffle-pancake to expand while cooking without the batter overflowing out of the waffle iron 101. This overflow problem, is the primary reason that the base 108 has a reservoir and the lid 102 has a thin profile that is designed to cover the hybrid waffle-pancake during cooking. The rib on the edge of the lid 102 should prevent the batter from escaping the waffle iron 101.

According to one embodiment, the user cooks the hybrid waffle-pancake for 1.5 minutes with the base applied to the heating element. Then the user grabs the lid handle 110 and the base handle 112 together in the closed configuration, as shown in FIG. 3A, and flips the waffle iron, so that the lid 102 is now on the cooking surface. The user cooks the hybrid waffle-pancake for 1.5 minutes with the lid 102 applied to the cooking surface. At this point, the user can check on the progress of the hybrid waffle-pancake by pulling the base 108 up with the base handle 112, and if the hybrid waffle-pancake is cooked to the desired temperature, texture and/or color, the user may remove it from the waffle iron 101. This may be done by shaking the waffle iron 101 and sliding the hybrid waffle-pancake onto a plate, or by using a spatula or other cooking utensil to move the hybrid waffle-pancake onto the plate. The cooking spray and the Teflon™ surface should ensure that the end-product is easily removed from the waffle iron 101. Further, the shape and depth of the protrusions of the waffle surfaces 140, 150 may improve the ability for the hybrid waffle-pancake to be removed from the waffle iron 101. In some embodiments, the hinge 106 is designed to adjust or pop to alert the user when the hybrid waffle-pancake is sufficiently cooked.

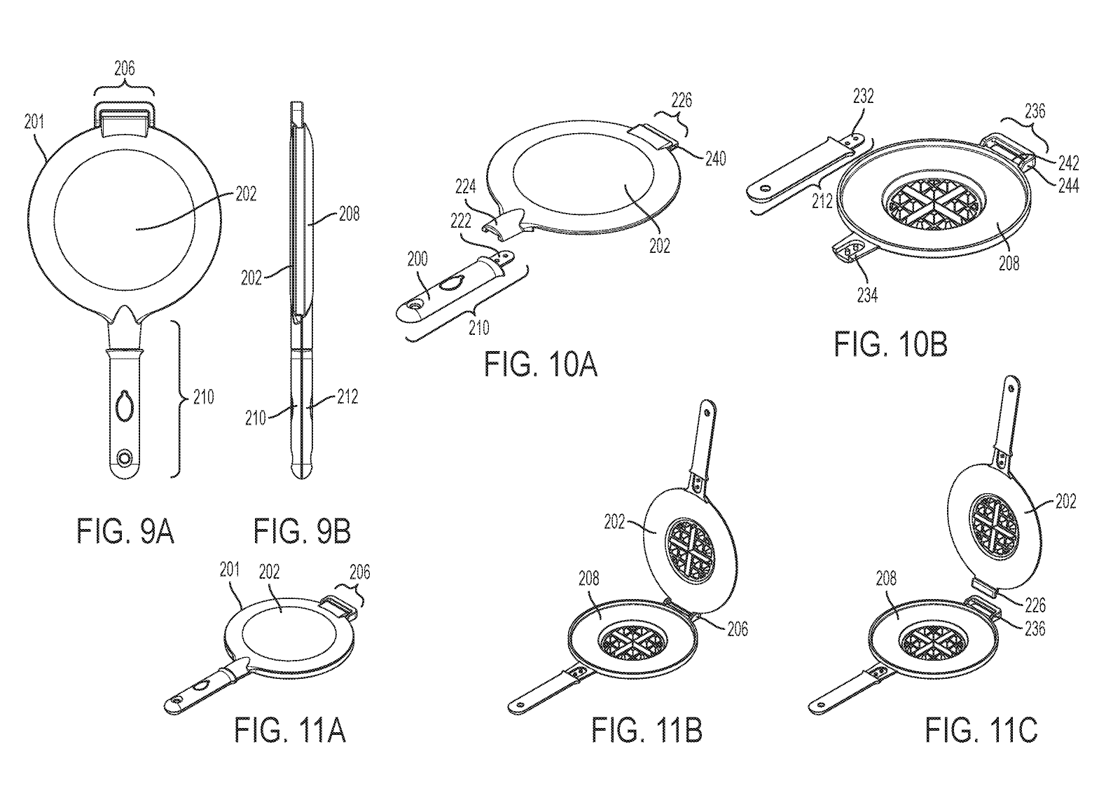

FIGS. 9A-11C illustrate an alternative embodiment of a waffle iron or cooking press 201. FIG. 9A illustrates a top view of a waffle iron 201 according to embodiments of the invention. This waffle iron or cooking press 201 is designed to cook a waffle and a pancake at the same time. A lid 202 is connected to a lid handle 210 and a hinge 206, which connects the lid to a base of the waffle iron 201. This hinge 206 is the primary difference between the waffle iron 101 of FIGS. 1-7 and the waffle iron 201 of FIGS. 9-11. The lid 202 is designed to enclose and cook the hybrid waffle-pancake. The lid handle 210 is adapted to allow a user to touch the handle 210 and adjust the lid 202 as desired. The hinge 206 comprises two portions that provide a removable connection between the lid 202 and the base 208.

FIG. 9B illustrates a side view of the waffle iron 201. The hinge 206 connects the lid 202 to the base 208 of the waffle iron or cooking press 201. Similar to the lid handle 210, the base handle 212 is connected to the base 208 and is adapted to allow a user to touch the handle 212 and adjust the base 208 as desired. Through the lid handle 210 and/or the base handle 212, the user may open and close the waffle iron 201. The hinge 206 is designed to allow this range of motion. As shown in FIG. 1B, the base 208 is thicker or deeper than the lid 202.

FIG. 10A illustrates a perspective view of the lid 202. The lid handle 210 includes a lid handle grip 220 and a lid handle tang 222. The tang 222 fits into the grip 220 to provide strength and rigidity to the lid handle 210. The lid handle 210 is connected to the lid 202 through a lid connector 224. There are two protrusions on the lid connector 224 that fit into two holes in the tang 222 for this connection. FIG. 10B illustrates a perspective view of the base 208. The base handle 212 includes a base handle grip 230 and a base handle tang 232. The tang 232 fits into the grip 230 to provide strength and rigidity to the base handle 212. The base handle 212 is connected to the base 208 through a base connector 234. As with the lid 202, there are two protrusions on the base connector 234 that fit into two holes in the tang 232 for this connection.

FIGS. 10A and 10B also illustrate a top portion of the hinge 226 connected to the lid 202 and a bottom portion of the hinge 236 connected to the base 208. As shown in FIGS. 11A-11C, the top 226 and bottom 236 portions of the hinge provide a removable connection between the lid 202 and the base 208. The top portion of the hinge 226 resembles a hook, latch, or finger 240, while the bottom portion of the hinge 236 resembles a cavity 242 for the hook, latch, or finger to fit in. The bottom portion of the hinge 236 includes a bracket or frame 244 that defines the cavity 242. The user may insert the finger (240) into the cavity (242) to connect the lid 202 to the base 208, and remove the finger (240) from the cavity (242) to separate the two. In some embodiments, the hook, latch, or finger 240 is formed to grab onto or fit around the bracket 244 of the cavity 242.

FIGS. 11A-11C are perspective views of the waffle iron or cooking press 201 in closed, open, and detached configurations. As shown in FIG. 11A, the lid 202 and base 208 fit together when the waffle iron 201 is closed. The top portion of the hinge 226 is connected to the bottom portion of the hinge 236 in the closed configuration. The waffle iron 201 should remain closed when it is applied to heat and the waffle and pancake are cooking. The lid 202 and the base 208 provide a sealed fit to prevent waffle and/or pancake batter from escaping the waffle iron 201. FIG. 11B shows the waffle iron 101 open with close to a 90° angle between the lid 102 and the base 108. The top portion of the hinge 226 remains connected to the bottom portion of the hinge 236 in this configuration. The open position enables the user to (1) check on the hybrid waffle-pancake during cooking and (2) remove the hybrid waffle-pancake when it has reached the desired temperature and texture. FIG. 11C illustrates the detachment of the lid 202 from the base 208, which allows the user to easily clean the waffle iron 201 after use. The design of the hinge 206 enables the top portion of the hinge 226 to separate from the bottom portion of the hinge 236 by removing the hook, latch, or finger 240 from the cavity 242.

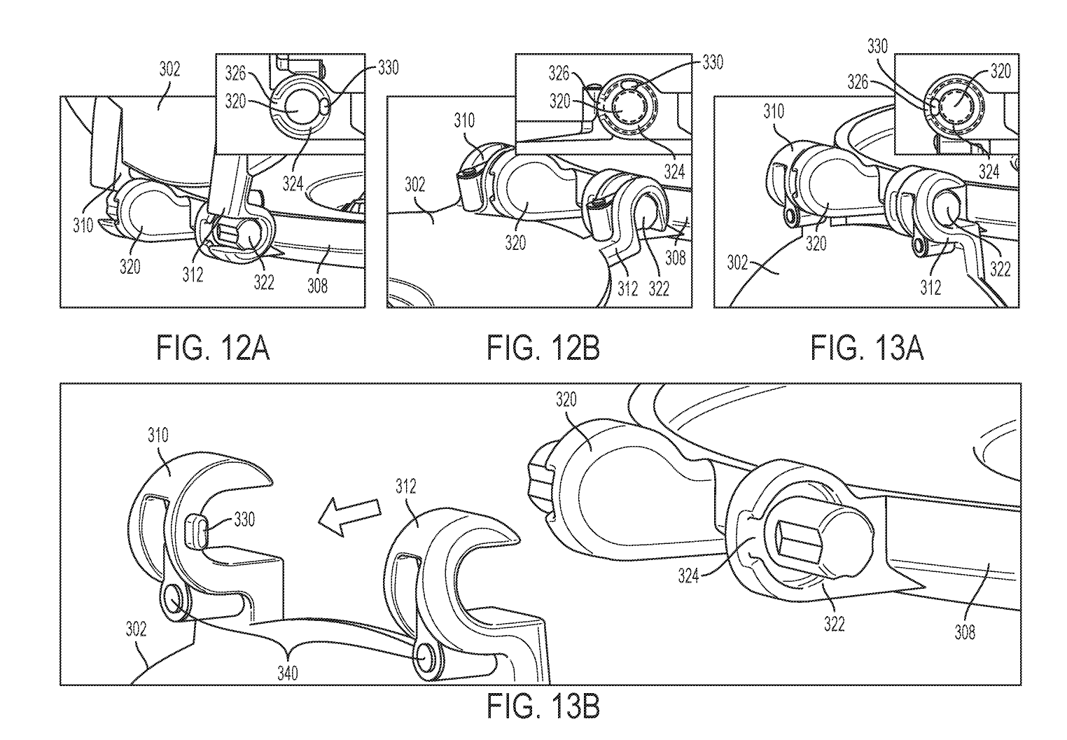

FIGS. 12A-13B illustrate an alternative embodiment for the hinge of a waffle iron or cooking press. As shown in FIG. 12A, the lid 302 is connected to the base 308 by a hinge that consists of a first lid knuckle 310, a second lid knuckle 312, a first base knuckle 320, and a second base knuckle 322. In this figure, the waffle iron is opened to a 90° angle between the lid 302 and the base 308. The first lid knuckle 310 and the second lid knuckle 312 are shaped as a hook, while the first base knuckle 320 and the second base knuckle 322 are designed as complementary cylindrical protrusions. Thus, the first lid knuckle 310 can rotate around the first base knuckle 320 as the waffle iron opens. The cross-section window of FIG. 12A illustrates that the first lid knuckle 310 includes a boss 330 that fits in a circular cavity 324 of the first base knuckle 320, which allows the boss 330 to move or rotate around the cylindrical protrusion of the first base knuckle 320. The first base knuckle 320 further comprises a hole or aperture 326 that provides an opening for the boss 322. In other embodiments, the second lid knuckle 312 may also have a similar boss that fits in a circular cavity of the second base knuckle 322.

In FIG. 12B, the waffle iron is opened to a 180° angle between the lid 302 and the base 308. The first lid knuckle 310 and the second lid knuckle 312 have rotated further about the first base knuckle 320 and the second base knuckle 322. The cross-section window of FIG. 12B illustrates that the boss 330 of the first lid knuckle 310 rotated further around the circular cavity 324 of the first base knuckle 320. At this angle the boss 330 is getting closer to the hole or aperture 326 in the first base knuckle 320.

In FIG. 13A, the waffle iron is opened to a 270° angle between the lid 302 and the base 308. The first lid knuckle 310 and the second lid knuckle 312 have rotated further about the first base knuckle 320 and the second base knuckle 322. The cross-section window of FIG. 13A illustrates that the boss 330 of the first lid knuckle 310 rotated further around the circular cavity 324 of the first base knuckle 320. At this angle the boss 330 is aligned with the hole or aperture 322 in the first base knuckle 320, and the user may slide the boss 330 through the hole or aperture 322 to detach the lid 302 from the base 308. This separation is shown in FIG. 13B. The detachment of the lid 302 from the base 308 allows the user to easily clean the waffle iron after use. This design of the hinge may also include a spring mechanism 340 to assist with the closure of the waffle iron. Specifically, the spring mechanism 340 pushes the lid 302 towards the base 308 when the waffle iron is open. This additional force further assists in keeping the lid 302 in the closed position during cooking.

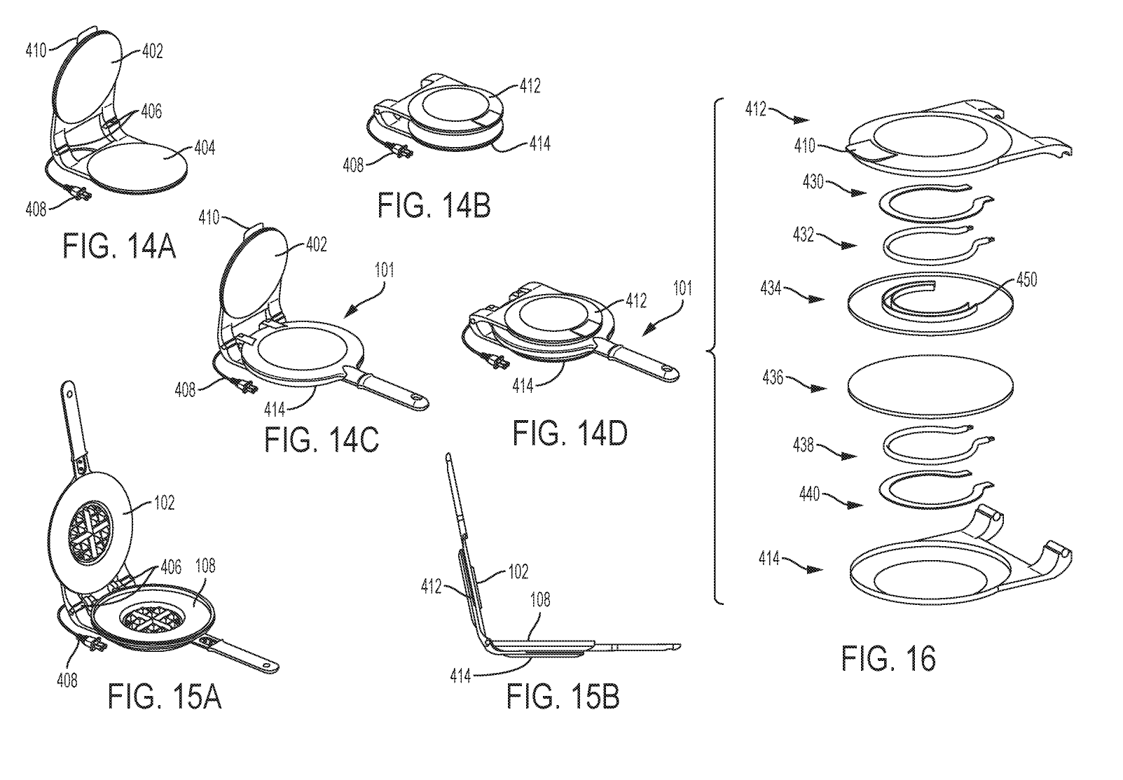

FIGS. 14A-14D illustrate an embodiment for an electric heating apparatus 401. In this embodiment, the electric heating apparatus 401 is a stand-alone product that works in conjunction with the waffle iron 101. As shown in FIG. 14A, the electric heating apparatus 401 comprises a first heating plate 402 and a second heating plate 404, which are connected to an adjustable bracket 406 that holds the heating plates 402, 404 in place. The adjustable bracket 406 can move the heating plates 402, 404 from the open position of FIG. 14A to the closed position of FIG. 14B. The adjustable bracket 406 includes a lid 412 and a base 416, which correspond to the lid 102 and base 108 of the waffle iron 101. In the closed position (FIG. 14B), a space remains between the lid 412 and the base 416 for the waffle iron 101 to fit into. A lid handle 410 is attached to the lid 412 to enable a user to open and shut the electric heating apparatus 401. An electrical cord 408 is used to supply power to the heating plates 402, 404.

FIGS. 14C and 14D show the electric heating apparatus 401 in use with the waffle iron or cooking press 101. The adjustable bracket 406 can move the heating plates 402, 404 from the open position of FIG. 14C to the closed position of FIG. 14D. In the open position, the base of the waffle iron 101 sits on the second heating plate 404, while the lid of the waffle iron 101 does not contact the first heating plate 402. This is how the user first puts the waffle iron 101 into the electric heating apparatus 401 and it may be used to check on the hybrid waffle-pancake. In the closed position, the base of the waffle iron 101 sits on the second heating plate 404 and the lid of the waffle iron 101 touches the first heating plate 402. The lid 412 may be used to close the electric heating apparatus 401 for cooking. FIGS. 15A and 15B illustrate the electric heating apparatus 401 being opened in conjunction with the waffle iron 101. These figures illustrate that the electric heating apparatus 401 and the waffle iron 101 share the same rotational axis. Thus, the user may open the waffle iron 101 and the electric heating apparatus 401 will open along with it. During this movement, the base 108 remains on the second heating plate 404 and the lid 102 moves with the first heating plate 402.

FIG. 16 shows and exploded view of the electric heating apparatus 401. The first heating plate 402 comprises a first cooking surface 434, an electric heating element 432, and a heat shield 430. The electric heating element 432 and the heat shield 430 fit into a cavity 450 of the first cooking surface 434. The electric cord 408 supplies electricity to the electric heating element 432, which heats up the first cooking surface 434. The heat shield 430 protects the lid 412 from the heat created by the electric heating element 432, and prevents the lid from getting too hot during the cooking process. The second heating plate 404 comprises a second cooking surface 436, an electric heating element 438, and a heat shield 440. The electric heating element 438 and the heat shield 440 fit into a cavity of the second cooking surface 436. The electric cord 408 supplies electricity to the electric heating element 438, which heats up the second cooking surface 436. The heat shield 440 protects the base 414 from the heat created by the electric heating element 438. This electric heating apparatus 401 is designed to be used as a heating element for the waffle irons 101, 201 disclosed herein. The waffle irons 101, 201 may not need to be flipped by the user with this apparatus 401. Otherwise, the hybrid waffle-pancake is cooked similarly to the method described above.

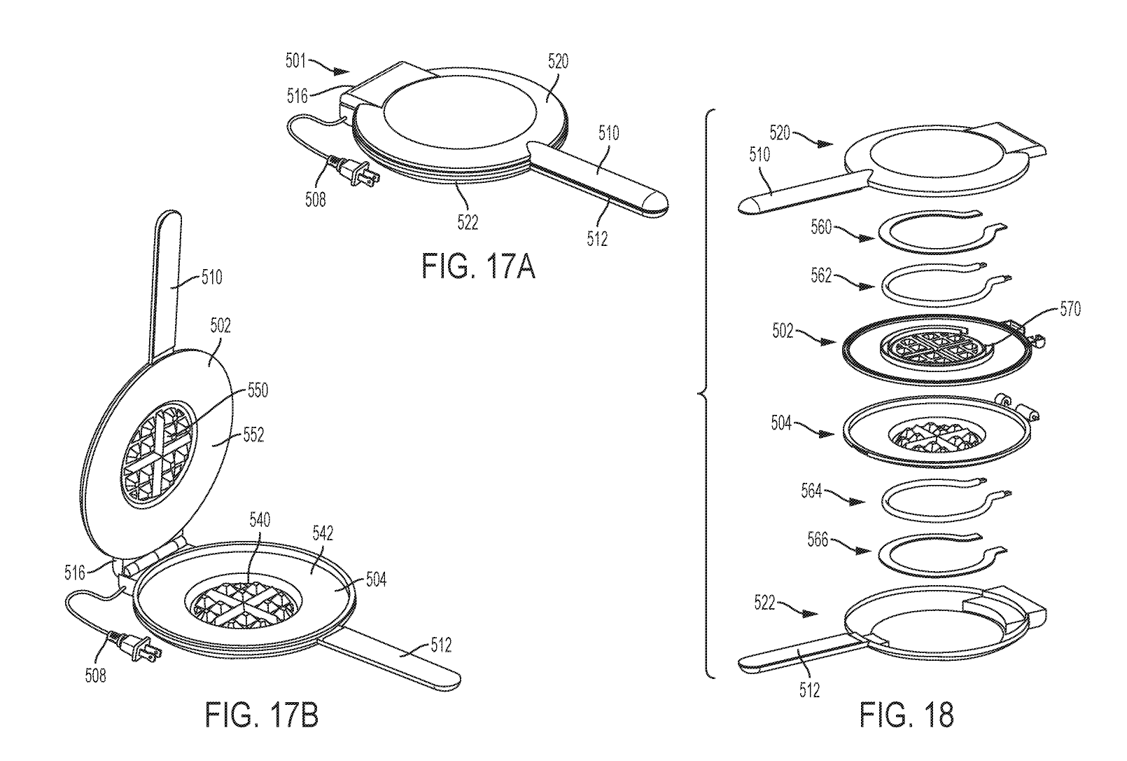

FIGS. 17A and 17B illustrate an embodiment for an electric waffle iron or cooking press 501 that is not designed to operate with the waffle irons 101, 201 disclosed herein. In this embodiment, the waffle iron or cooking press 501 is a stand-alone product that comprises a lid 520, a base 522, and a hinge 516. The hinge 516 may be a standard hinge that is designed to connect the lid 520 and the base 522, while allowing a user to open and close the waffle iron 501. A lid handle 510 and a base handle 512 may be used to open the electric waffle iron 501. The electric waffle iron 501 includes an electric cord 508 to supply electricity. As shown in FIG. 17B, the electric waffle iron 501 further comprises a first cooking surface 502 connected to the lid 520 and a second cooking surface 504 connected to the base 522. The second cooking surface 504 is deeper than the first cooking surface 502. The cooking surfaces 502, 504 heat up to cook the waffle and pancake. The cooking surfaces 502, 504 comprise waffle surfaces 540, 550 for cooking a waffle and pancake surfaces 542, 552 for cooking a pancake. The waffle surfaces 540, 550 include complementary protrusions, ridges, apertures, and gaps for creating a textured waffle. Various designs for these waffle surfaces 540, 550 can be used to create the desired waffle. For example, the waffle surfaces 540, 550 may be deeper to create a thicker waffle, which would make the protrusions taller as well. There may be more protrusions to create more apertures or gaps within the waffle. The pancake surfaces 542, 552 may be flat surfaces for creating flat pancakes. When heated, the cooking surfaces 502, 504 cook the hybrid waffle-pancake to the desired temperature and texture. The waffle surfaces 540, 550 are deeper than the pancake surfaces 542, 552 so that the waffle portion of the end-product is thicker than the pancake portion.

FIG. 18 shows an exploded view of the electric waffle iron or cooking press 501. The first cooking surface 502 includes an electric heating element 562 and a heat shield 560. The electric heating element 562 and the heat shield 560 fit into a cavity 570 of the first cooking surface 502. The electric cord 508 supplies electricity to the electric heating element 562, which heats up the first cooking surface 502. The heat shield 560 protects the lid 520 from the heat created by the electric heating element 562, which prevents the lid from getting too hot during the cooking process. The second cooking surface 504 includes an electric heating element 564 and a heat shield 566. The electric heating element 564 and the heat shield 566 fit into a cavity of the second cooking surface 504. The electric cord 508 supplies electricity to the electric heating element 564, which heats up the second cooking surface 504. The heat shield 566 protects the base 522 from the heat created by the electric heating element 564. Waffle irons or cooking presses 101, 201 are not required, and the user is not required to flip the electric waffle iron 501 in this embodiment. Otherwise, the hybrid waffle-pancake is cooked similarly to the method described above.

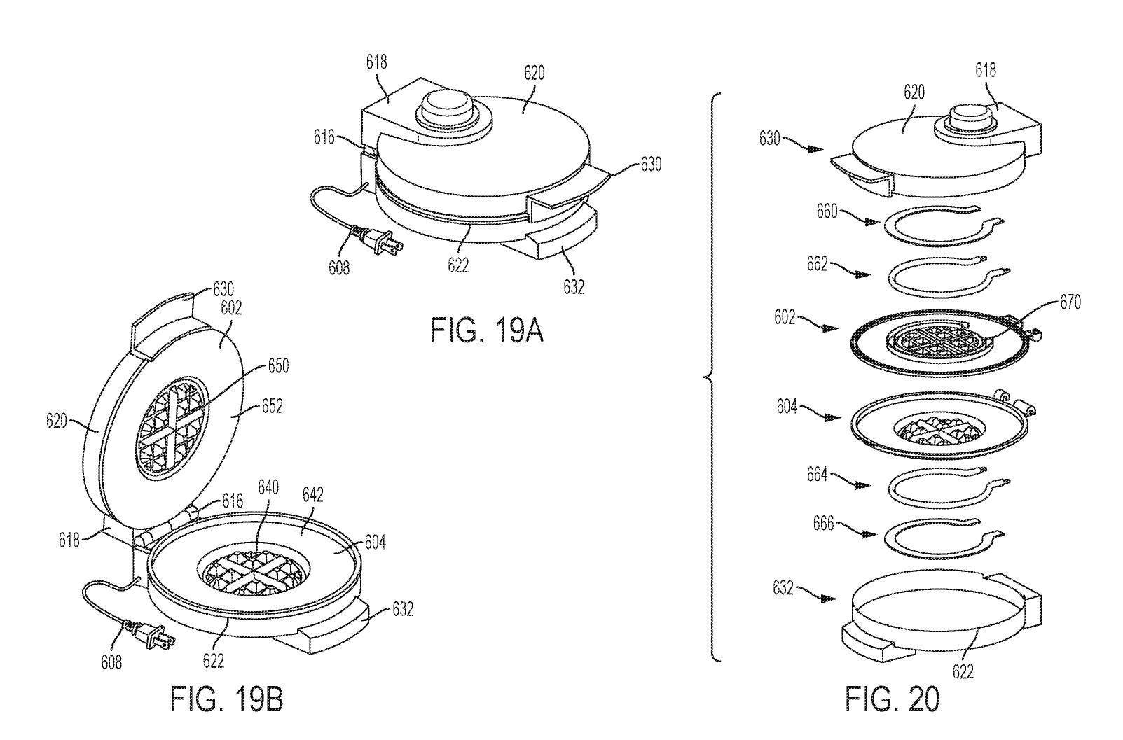

FIGS. 19A and 19B illustrate an alternative embodiment for an electric waffle iron or cooking press 601. In this embodiment, the waffle iron 601 is a single product that comprises a lid 620, a base 622, a frame 618, and a hinge 616. The frame 618 and the hinge 616 may be similar to a standard frame and hinge that are designed to connect the lid 620 and the base 622, while allowing a user to open and close the waffle iron 601. A lid handle 630 and a base handle 632 may be used to open the electric waffle iron 601. The electric waffle iron 601 includes an electric cord 608 to supply electricity. As shown in FIG. 17B, the electric waffle iron 601 further comprises a first cooking surface 602 connected to the lid 620 and a second cooking surface 604 connected to the base 622. The second cooking surface 604 is deeper than the first cooking surface 602. The cooking surfaces 602, 604 heat up to cook the hybrid waffle-pancake. The cooking surfaces 602, 604 comprise waffle surfaces 640, 650 for cooking a waffle and pancake surfaces 642, 652 for cooking a pancake. The waffle surfaces 640, 650 include complementary protrusions, ridges, apertures, and gaps for creating a textured waffle. Various designs for these waffle surfaces 640, 650 can be used to create the desired waffle. For example, the waffle surfaces 640, 650 may be deeper to create a thicker waffle, which would make the protrusions taller as well. There may be more protrusions to create more apertures or gaps within the waffle. The pancake surfaces 642, 652 are flat surfaces for creating flat pancakes. When heated, the cooking surfaces 602, 604 cook the hybrid waffle-pancake to the desired temperature and texture. The waffle surfaces 640, 650 are deeper than the pancake surfaces 642, 652 so that the waffle portion of the end-product is thicker than the pancake portion.

FIG. 20 shows an exploded view of the electric waffle iron or cooking press 601. The first cooking surface 602 includes an electric heating element 662 and a heat shield 660. The electric heating element 662 and the heat shield 660 fit into a cavity 670 of the first cooking surface 602. The electric cord 608 supplies electricity to the electric heating element 662, which heats up the first cooking surface 602. The heat shield 660 protects the lid 620 from the heat created by the electric heating element 662, which prevents the lid from getting too hot during the cooking process. The second cooking surface 604 includes an electric heating element 664 and a heat shield 666. The electric heating element 664 and the heat shield 666 fit into a cavity of the second cooking surface 604. The electric cord 608 supplies electricity to the electric heating element 664, which heats up the second cooking surface 604. The heat shield 666 protects the base 622 from the heat created by the electric heating element 664. Waffle irons or cooking presses 101, 201 are not required, and the user is not required to flip the electric waffle iron 601 in this embodiment. Otherwise, the hybrid waffle-pancake is cooked similarly to the method described above.

The electric heating apparatus 401, the electric waffle iron 501, and the electric waffle iron 601 may have buttons, knobs, displays, or touch screens for controlling the cook temperature and time. For example, a user may be able to use the touch screen to select the cooking time and temperature for the hybrid waffle-pancake. LED lights may also be used to inform the user that the hybrid waffle-pancake are done. A green light indicates that the hybrid waffle-pancake are cooking, while a red light indicates that the hybrid waffle-pancake are finished. The cooking information may also be transmitted to a mobile device application or website with a transmitter. This would allow a user to track the progress of electric waffle iron 501, 601. At least a sensor and a microprocessor within the waffle iron 501, 601 may be required for this embodiment.

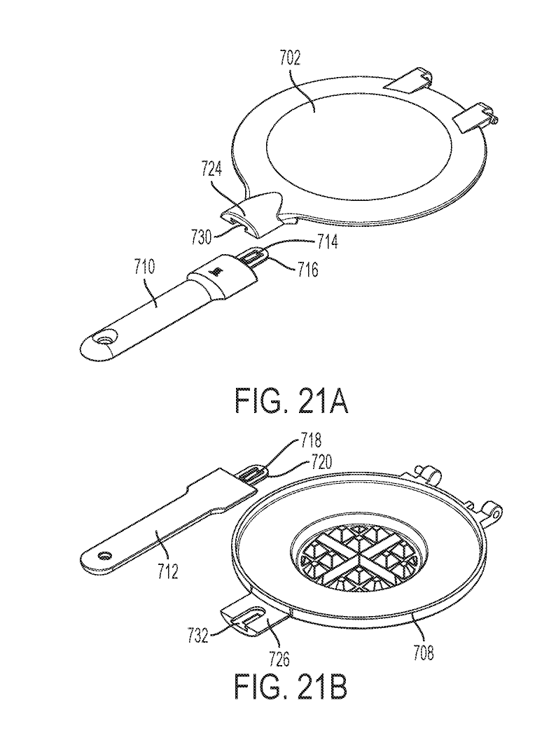

FIGS. 21A and 21B illustrate a perspective view of an alternative embodiment for a waffle iron or cooking press 701, which includes a lid 702 and a base 708. The lid 702 may be similar to the lid 102 disclosed in FIG. 2A, and the base 708 may be similar to the base 108 disclosed in FIG. 2B. However, a lid handle 710, a lid connector 724, a base handle 712, and a base connector 726 enable the user to detach the lid handle 710 and the base handle 712 from the lid 702 and base 708. The lid handle 710 includes a lid tang 716 which has a protrusion, rail, or extension 714 that matably engages with an aperture, frame, or gap 730 in the lid connector 724. This connection allows the user to slide the lid handle 710 into and back out of the lid connector 724. The base handle 712 includes a base tang 720 which has a protrusion, rail, or extension 718 that matably engages with an aperture, frame, or gap 732 in the base connector 726. This connection allows the user to slide the base handle 712 into and back out of the base connector 726. The lid handle 710 and the base handle 712 may include a button or knob that causes the protrusion, rail, or extension 714, 718 to appear or disappear when actuated. With a corresponding aperture, frame, or gap in the lid connector 724 and base connector 726 the user could attach or detach the handles 710, 712 as necessary. There may also be a flexible protrusion or rail within the lid connector 724 and base connector 726 that will slide into place when the lid handle 710 or base handle 712 is inserted to prevent the handles 710, 712 from detaching during operation. Then the user may detach the handles 710, 712 by actuating a button or knob on the handles 710, 712. The user may also attach and detach the handles 710, 712 by using a wrench or screwdriver with corresponding bolts or fasteners.

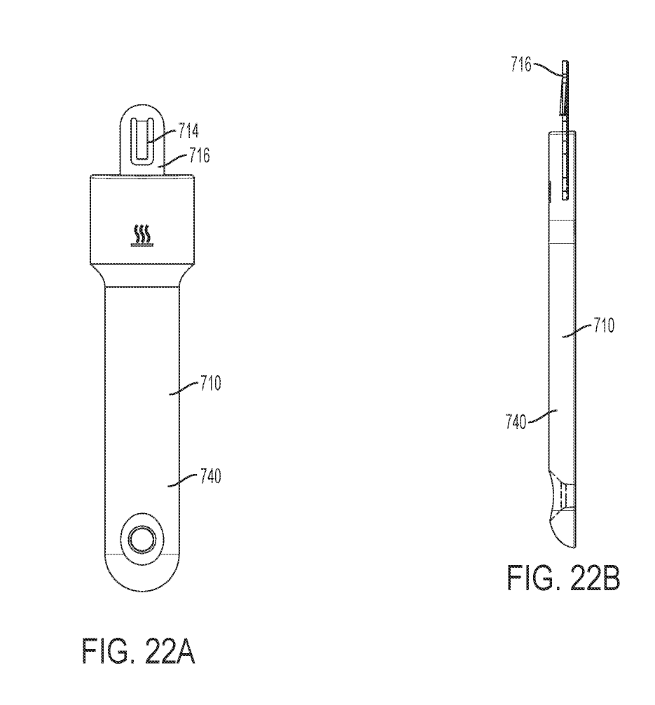

FIGS. 22A and 22B illustrate a top view and a side view of the lid handle 710, which connects to the lid 702. The base handle 712 is substantially similar, but may need to be thicker due to the thicker reservoir. The lid tang 716 includes a protrusion, rail, or extension 714 that matably engages with the lid connector 724. The lid tang 716 may be made of stainless steel or aluminum to provide strength and rigidity to the handle. The lid tang 716 may have numerous holes or apertures located inside the lid handle grip 740. The lid handle grip 740 surrounds the lid tang 716 with a cushioned surface that a user can grab and hold. In some embodiments, the lid handle grip 740 is a thermoset plastic material (i.e., Bakelite, Phenolic resins, etc.) that does not conduct heat well. Thus, the user can grab the lid handle grip 740 even when the lid 702 is hot. During manufacturing, the holes in the lid tang 716 may fill with the thermoset plastic material to improve strength and durability of the lid handle 710.

Some embodiments may include decorative or personalized additions to the waffle irons or cooking presses 101, 201, 501, 601, 701. For example, letters, logos, cartoon characters, or shapes may be attached to the interior of the waffle iron or cooking press. This may be used to create a hybrid waffle-pancake with a heart shape or a name stamped on it. A hole, aperture, or latch within the inside surface of the waffle iron may be used to attach the letters, logos, or shapes. Magnets could also be used to attach the letters, logos, or shapes to the interior of the waffle iron or cooking press. In some embodiments, the cooking surfaces could be replaced with alternative shapes, symbols, or cartoon characters. For example, the cooking surfaces of the electric waffle iron may be removable such that they could be replaced with heart-shaped surfaces that would create a different hybrid waffle-pancake. Similarly, the waffle surfaces of the lid and base could be replaced with substitute cooking surfaces that create a different foodstuff resembling the inserts (i.e., waffles that spell a name or pancakes that create a symbol or cartoon character). Fasteners, latches, or magnets could be used to remove and replace these cooking surfaces.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A cooking press, said cooking press comprising:
a base comprising a first pancake surface and a first waffle surface;
a lid comprising a second pancake surface and a second waffle surface, wherein said second pancake surface is complementary to said first pancake surface and said second waffle surface is complementary to said first waffle surface; and
a hinge mechanism for connecting said lid to said base, wherein said hinge mechanism enables a user to attach said lid to said base, open said lid with respect to said base, and detach said lid from said base;
wherein said first pancake surface and said second pancake surface are substantially flat and said first waffle surface and said second waffle surface are configured in a grid pattern;
wherein said cooking press is configured to create a hybrid waffle-pancake foodstuff by allowing a user to apply heat to said first and second pancake surfaces and said first and second waffle surfaces.

2. The cooking press of claim 1 wherein said first waffle surface and said second waffle surface comprise complementary protrusions and gaps.

3. The cooking press of claim 1 further comprising a lid handle that connects to said lid and a base handle that connects to said base, wherein said lid handle is detachable from said lid and said base handle is detachable from said base.

4. The cooking press of claim 1 further comprising a lid handle that connects to said lid and a base handle that connects to said base, wherein a top side of said lid handle does not extend beyond a top side of said lid and a bottom side of said base handle does not extend beyond a bottom side of said base

5. The cooking press of claim 1 wherein a cross section of said base is thicker than a cross section of said lid.

6. The cooking press of claim 5 wherein a cross section of said second waffle surface of said lid is thicker than a sidewall of said lid such that said second waffle surface extends into said base when the cooking press is in a closed configuration.

7. The cooking press of claim 1 wherein said hinge mechanism further comprises at least one protrusion and at least one complementary aperture for attaching said lid to said base.

8. The cooking press of claim 7 wherein the cooking press further comprises a boss and a complementary aperture that are designed to prevent said lid from detaching from said base during operation of said cooking press.

9. A cooking press, said cooking press comprising:
a lid;
a base comprising a first pancake surface that is configured to create a pancake foodstuff and a first waffle surface that is configured to create a waffle foodstuff;
a hinge mechanism for connecting said lid to said base, wherein said hinge mechanism is configured to enable a user to open said lid with respect to said base;
an insulated lid handle that is configured to connect to said lid; and
an insulated base handle that is configured to connect to said base;
wherein said cooking press is configured to create a hybrid waffle-pancake foodstuff by allowing a user to apply heat to said lid, said first pancake surface, and said first waffle surface, wherein said pancake foodstuff is connected to said waffle foodstuff.

10. The cooking press of claim 9 wherein said lid further comprises a second pancake surface that is complementary to said first pancake surface and a second waffle surface that is complementary to said first waffle surface.

11. The cooking press of claim 10 wherein said first waffle surface and said second waffle surface are configured in a grid pattern.

12. The cooking press of claim 11 wherein a cross section of said second waffle surface of the lid is thicker than a sidewall of said lid such that said second waffle surface extends into said base when said cooking press is in a closed configuration.

13. The cooking press of claim 9 wherein a top side of said insulated lid handle does not extend beyond a top side of said lid and a bottom side of said insulated base handle does not extend beyond a bottom side of said base.

14. The cooking press of claim 9 wherein said hinge mechanism is further configured to enable a user to attach said lid to said base and detach said lid from said base.

15. The cooking press of claim 14 wherein:
said hinge mechanism comprises a first lid knuckle, a second lid knuckle, a first base knuckle and a second base knuckle;
wherein said first lid knuckle is configured to connect to said first base knuckle and said second lid knuckle is configured to connect to said second base knuckle.

16. The cooking press of claim 15 wherein said base comprises a boss and said first lid knuckle comprises an aperture that is complementary to the boss, wherein said boss and said aperture are designed to prevent said lid from detaching from said base during operation of said cooking press.

17. A cooking press, said cooking press comprising:
a base comprising a first pancake surface and a first waffle surface;
a lid comprising a second pancake surface and a second waffle surface, wherein said second pancake surface is complementary to said first pancake surface and said second waffle surface is complementary to said first waffle surface;
a hinge mechanism for connecting said lid to said base, wherein said hinge mechanism is configured to enable a user to open said lid with respect to said base; and
at least one heating element that is connected to a power supply for heating said lid and said base;
wherein said first pancake surface and said second pancake surface are substantially flat and said first waffle surface and said second waffle surface are configured in a grid pattern;
wherein said cooking press is configured to create a hybrid waffle-pancake foodstuff by applying heat to said first and second pancake surfaces and said first and second waffle surfaces.

18. The cooking press of claim 17 wherein said first waffle surface and said second waffle surface comprise complementary protrusions and gaps.

19. The cooking press of claim 17 wherein a cross section of said base is thicker than a cross section of said lid.

20. The cooking press of claim 17 wherein a cross section of said second waffle surface of said lid is thicker than a sidewall of said lid such that said second waffle surface extends into said base when said cooking press is in a closed configuration.
